(19) United States
(12) Patent Application Publication
(10) Pub. No.: US 2011/0290420 A1
(43) Pub. Date: Dec. 1, 2011

(54) MANUAL WELDER

(75) Inventor: Michael DIETRICH, Stolberg (DE)

(73) Assignee: Wegener International GmbH, Aachen (DE)

(21) Appl. No.: 13/117,277

(22) Filed: May 27, 2011

(30) Foreign Application Priority Data
Jun. 1, 2010 (DE) 20 2010 007 466

(51) Int. Cl. B29C 65/40; B29C 65/02

(52) U.S. Cl. 156/359; 156/499

(57) ABSTRACT

The invention relates to a hand welder (1) for welding plastic workpieces by melting a plastic welding filler, comprising a feed device (4) for feeding the welding filler into a melting device (5) for melting the welding filler and to which a welding head (7) with an outlet (58) for the molten welding filler is attached on the outlet side, which is characterised in that the melting device (5) has at least two melting units (24, 25) disposed next to one another, and every melting unit (24, 25) has its own passage channel (38, 39) for the welding filler, the passage channels (38, 39) opening out into a mixing head (6) for mixing the molten welding fillers passing out of the passage channels (38, 39).

The invention relates to a hand welder for welding plastic workpieces by melting a plastic welding filler, comprising a feed device for feeding the welding filler into a melting device for melting the welding filler and to which a welding head with an outlet for the molten welding filler is attached on the outlet side.

This type of manual welder is known, for example, from DE 38 08 723 C1, DE 38 35 250 C1, U.S. Pat. No. 5,005,731 A, DE 42 36 281 C2, EP 0 663 277 A1, DE 297 18′972 U1, DE 299 21 650 U1, EP 1 083 037 B1, EP 1 634 688 B1, EP 1 634 689 A1, EP 1 637 234 B1, DE 20 2005 000 130 U1 and DE 20 2007 014 871 U1. They are used for welding plastic workpieces, for example sheets made of plastic or the like. Despite the designs which differ in the detail, their basic structure has remained the same for decades. They have a drive in the form of or similar to a hand drill which is provided with a detachably fitted attachment. This attachment includes a feed device for feeding a welding filler into a melting device which is intended for melting the welding filler conveyed to this point. For this purpose the melting device has a heating device which is assigned to an elongate melting housing through which a passage channel passes. In the melting device the plastic respectively used as the welding filler is heated to such a temperature that it melts. For this purpose the melting device is surrounded by a heating device. The molten welding filler then passes into the welding head and passes out here for the purpose of facilitating the welding process.

Plastics in the form of granules or wire can be used as the welding filler. In the latter case the feed device has a wire feed channel and an adjoining feeder screw which can be set in rotary motion by the drive. The feeder screw has a single- or multi-start feeder thread on its jacket. A number of feeder channels can also be provided here so as to make it possible to feed plastic wires with different diameters or to feed a number of plastic wires simultaneously. The feed device or the feeder screw is matched to the diameter of the plastic wire such that when introduced by the feeder thread of the feeder screw the plastic wire is grasped, drawn in in the axial direction and conveyed in the direction of the melting device.

In many cases a reducing device is additionally disposed between the feed device and the melting device in which the plastic wire is fragmented so that it passes into the melting device in granular form.

In many instances the melting device is in the form of an extruder unit. In this case an extruder screw passes through the passage channel and is connected via the feed device and the feeder screw present here to the drive. When operating the hand welder the extruder screw is set in rotary motion for the purpose of conveying the welding filler. Mechanical energy is converted into thermal energy here by the friction within the passage channel, and this facilitates the melting process. With simple hand welders one dispenses with this type of extruder screw (see DE 298 18 757 U1).

Hand welders of the type described above have proved to be of value for the welding of plastic workpieces with wall thicknesses of up to 30 mm. Here the throughput (volumetric flow) of welding filler must be greater the thicker the wall thickness of the workpieces to be welded. The greater the throughput the greater must be not only the diameter of the passage channel of the melting device, but also its length. At the moment, with the largest hand welders of this type there is a throughput of 6.2 kg/h in the case of polyethylene and 5.2 kg/h in the case of polypropylene as a welding filler. An increase in the throughput in order to be able to weld plastic workpieces with an even greater wall thickness would make the hand welder so cumbersome due to the dimensions of the melting device that it would hardly be manageable for an operator, in particular when weld seams have to be produced in cramped spaces. Due to the flexibility of use of these hand welders there is however a need to also use them when welding plastic workpieces with wall thicknesses for which they were previously not suitable.

Consequently, the object forming the basis of the invention is to develop a hand welder that despite clearly increased throughput has good manageability and operability.

This object is achieved according to the invention in that the melting device has at least two melting units disposed next to one another—or also more than two, i.e. three or four melting units—and every melting unit has its own passage channel for the welding filler, the passage channels opening out into a mixing head for mixing the molten welding fillers passing out of the passage channels. Therefore, the main idea behind the invention is to plasticise the welding filler in two or more melting units disposed next to one another, and to combine the two flows of welding filler in one mixing head so as to then allow it to pass out via the welding head. In comparison with a hand welder with a single melting unit of the same length the throughput can be doubled if two of these melting units are provided. Nevertheless, the manageability of the hand welder according to the invention hardly suffers because its dimensions only change slightly. Therefore, it can still also be used in cramped spaces, but now also for welding plastic workpieces with considerably greater wall thicknesses. The scope for the use of these hand welders is greatly broadened by doubling the throughput. Only a somewhat greater weight needs to be taken into account. This can, however, be managed, for example, by a carrying device.

In the design of the invention provision is made such that the passage channels extend parallel to one another. However, this does not prevent the passage channels e.g. from being aligned such that they come together in a V shape in the direction of the mixing head.

The principle according to the invention is also basically suitable for melting devices without extruder screws in the passage channels so that the melting is brought about purely by the heating device (see DE 298 18 757 U1). For the high throughputs that are desirable here melting units which are in the form of extruder units with extruder screws disposed in the passage channels are suitable however, the extruder screws being coupled on the input side to a drive device by means of which they can be set in rotation. It is basically possible here to provide a corresponding drive motor for every extruder screw. Since it is less expensive and lighter, it has been shown to be advantageous, however, to provide a single drive motor which is connected to the extruder screws by means of a transfer box. Toothed belt, chain or pinion gears can be considered as transfer boxes. Due to the average noise development and the small installation space the latter constitute a practical compromise. One advantageous embodiment of this type of gear mechanism is in the form of spur gearing with a first gear wheel on the drive side and gear wheels on the extruder side which cog directly and/or indirectly with the first gear wheel. The gear wheels are advantageously provided with helical gearing.

The transfer box is disposed within a gear housing which has a flange for the drive motor on the drive side. In this way no further housing is required for the drive motor.

Due to the power required here an electric motor is less suitable as a drive motor because with these requirements it has a relatively great weight. A hydraulic motor has a considerably greater power density. It is therefore particularly suitable for the requirements of the hand welder according to the invention. For reasons relating to weight the hydraulic motor should be connected or connectable by means of flexible hoses to a separate hydraulic pump. Basically all embodiments can be considered as hydraulic motors, for example axial piston, radial piston, wing cell or rotary valve motors, but also gear motors as internally or externally toothed variations. Gerotor motors are particularly suitable, for example in the form of an orbital motor, because they are low-speed motors and are capable of providing the power required here, even with low rotation speeds and nevertheless small overall sizes. By using these motors a reduction in the transfer box is not necessary, i.e. in the case of a gear mechanism gear wheels with the same diameter can be used, and this is cost-effective.

If a mineral oil suitable for lubrication is used for the operation of the hydraulic motor it is advantageous to establish a connection to the transfer box such that the hydraulic oil conveyed by the hydraulic pump flows through the transfer box in order to lubricate the latter. In this way lubrication of the transfer box is guaranteed without any vital additional measures.

In a particularly preferred embodiment the melting units should be separated from one another, i.e. not be directly connected to one another, but at best via additional components such as a transfer box and/or a mixing head. The advantage of this is that melting units from the ranges of existing hand welders can be used without any further changes. In this way there can be formed from an existing range of hand welders a range of hand welders according to the invention which respectively have double the throughput in comparison to the construction type of which the melting unit is used (or three times the output if three melting units are combined with one another in the way according to the invention etc.). Needless to say, this does not rule out giving the melting units a common melting housing through which two or more passage channels then pass.

Connected to the melting unit, the mixing head should have a first section with outlet channels opening out into one another and a second section adjoining the first which has a mixing channel preferably with a static mixing insert. Mixing inserts such as, for example, those according to EP 1 815 904 A1 or EP 1 924 346 B1 can be considered. They provide intensive mixing of the two flows of welding filler coming from the passage channels of the melting units without opposing a greater resistance. The first and second section should form two separated components here which are, however, connected to one another.

So that with a cold start the welding filler remaining in the mixing head can be melted and does not cool down too rapidly as it flows through the mixing head, the mixing head should be provided with a heating device which is preferably coupled to its own temperature regulating device.

In a further embodiment of the invention provision is made such that the feed device consists of separate feed units, and a particular feed unit is assigned to every melting unit. Here the units comprising the melting unit and the respective corresponding feed unit should be separated from one another. In this respect too one can then fall back on the existing hand welders, i.e. the melting unit combined with the feed unit can also be adopted unchanged from these hand welders. If the hand welder has extruder units with a drive device, every feed unit should have its own wire feed and its own feeder screw, every feeder screw being disposed coaxially to the respective corresponding extruder screw and being connected to the latter, and the feeder screws being coupled to the drive device.

In a further embodiment of the invention provision is made such that the melting units have separate heating units with temperature regulating devices which are independent of one another. In this way it is ensured that melting of the welding filler reliably takes place in each of the melting units.

According to the invention provision is further made such that a hot air device is provided for pre-heating the weld seam and which has an outlet opening close to the welding head and is provided with its own temperature regulating device. By means of this hot air device hot air with a temperature of 250 to 400° C. is blown onto the welding point in order to plasticise it. For reasons relating to weight the hot air device should have a separate hot air generator which is coupled or can be coupled by a hot air hose to a hot air pipe leading to the welding head and connected to the hand welder.

In the drawings the invention is illustrated in greater detail by means of an exemplary embodiment. These show as follows:

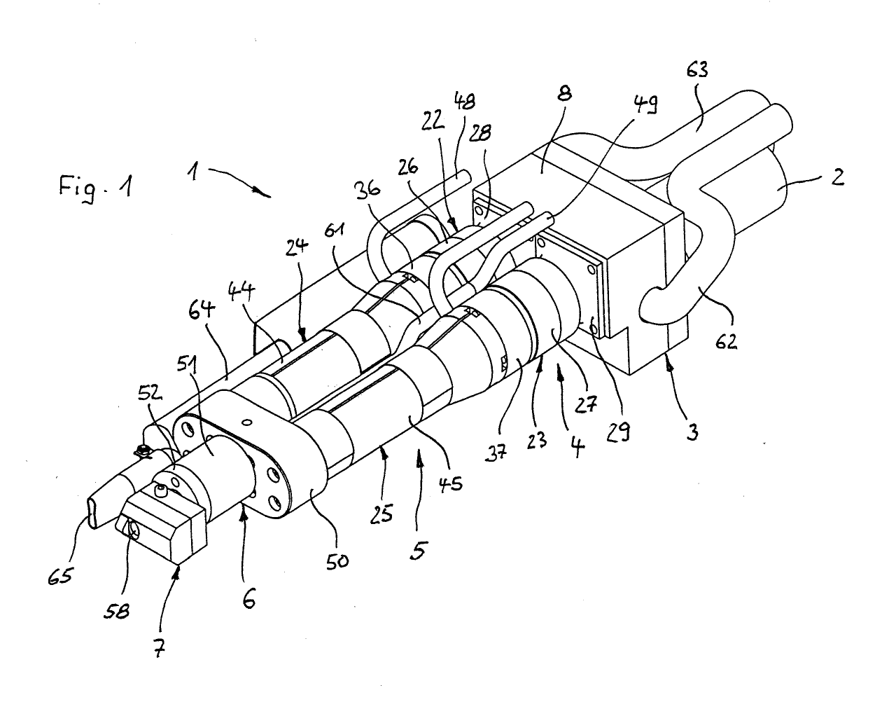

FIG. 1 an oblique view of the hand welder according to the invention without handles,

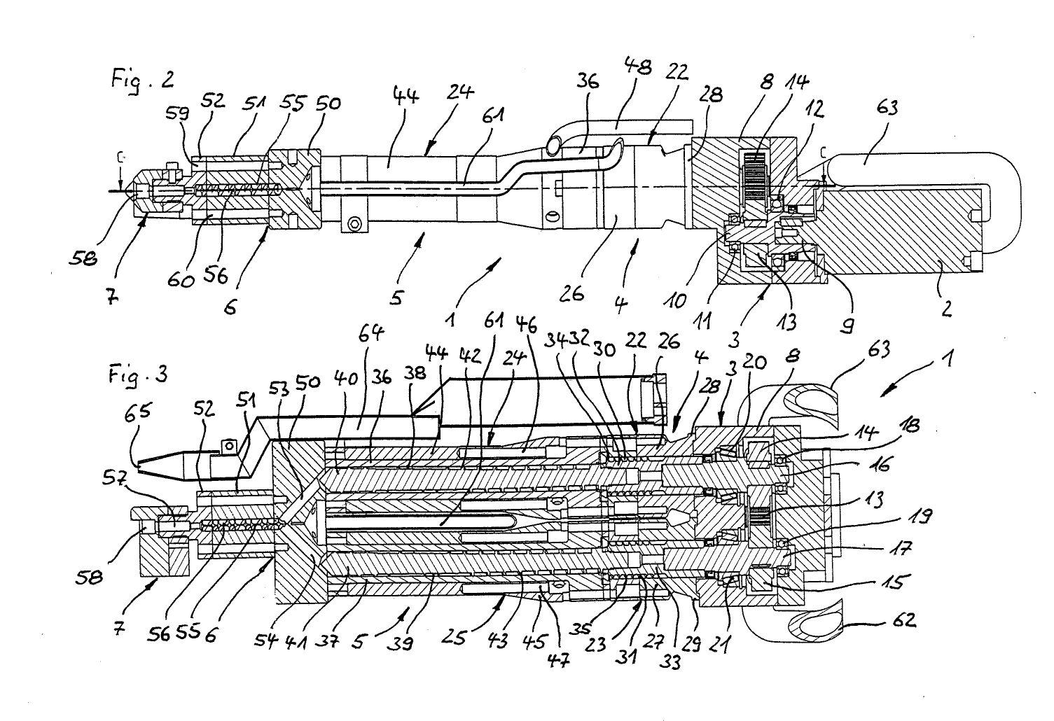

FIG. 2 a vertical longitudinal section through the hand welder according to FIG. 1, and

FIG. 3 a horizontal longitudinal section (plane C-C in FIG. 2) through the hand welder according to FIGS. 1 and 2.

The hand welder 1 shown in the figures consists of the following main parts in the order from the back to the front, namely a hydraulic motor 2 in the form of an orbital motor, a transfer box 3, a feed device 4 with a granulating device and thermal separation, a melting device 5, a mixing head 6 and a welding head 7. Not shown are the handles for handling the hand welder 1 which are provided for fitting beneath the transfer box 3 and laterally to the latter.

As can be seen in particular in FIGS. 2 and 3, the hydraulic motor 2 is flanged onto the rear side of the gear housing 8 of the transfer box 3. It has an output shaft 9 which is connected, torque-proof, to a gear shaft 10. The gear shaft 10 is mounted in ball bearings 11, 12 in the gear housing 8. Sitting on the latter is a first spur gear 13 that directly cogs with two second spur gears 14, 15 above the latter and arranged next to one another. Therefore, the centre points of the three spur gears 13, 14, 15 form a triangle. The second spur gears 14, 15 sit, torque-proof, on gear shafts 16 and 17 which are mounted at their rear ends in ball bearings 18 and 19 and at the front side on oblique ball bearings 20 and 21.

The feed device 4 adjoining the transfer box 3 is divided into two feed units 22, 23—each provided with its own granulating device consisting of a multi-blade blade wheel and isolating discs on the outside—and the subsequent melting device 5 divided into two melting units 24, 25. The feed unit 22 and the melting unit 24 as well as the feed unit 23 and the melting unit 25 respectively form cohesive units here which are not directly connected to one another, but lie next to one another.

The feed units 22, 23 each have a feed housing 26 and 27 which are connected independently of one another to the gear housing 8 of the transfer box 3 by means of flanges 28 and 29. There are located within the feed housing 26, 27 feeder channels 30 and 31 with circular cross-sections which are aligned parallel to one another and in which feeder screws 32 and 33 are rotatably disposed which carry a feeder thread 34 and 35 on the outside. In a coaxial position the feeder screw 32 is connected, torque-proof, to the gear shaft 16, and in the coaxial position the feeder screw 33 is also connected, torque-proof, to the gear shaft 17. Feeder channels, separate from one another and passing obliquely through the feed housing 26 and 27, which are not detailed here, and by means of which the one respective welding filler made of plastic in the form of wire can be fed in, open out into the feeder channels 30, 31.

The melting unit 24 is flanged onto the front face side of the feed housing 26 and the melting unit 25 is flanged onto the front face side of the feed housing 27. The melting units 24, 25 each have an elongate melting housing 36 and 37 through which a cylindrical passage channel 38 and 39 respectively passes. On the feed side the passage channels 38, 39 are connected to the respective corresponding feeder channel 30 and 31. An extruder screw 40 and 41 is respectively disposed in the passage channels 38, 39. On the outside the extruder screws 40, 41 have a screw thread 42, 43. The extruder screw 40 is connected torque-proof to the feeder screw 32 and the extruder screw 41 to the feeder screw 33.

The melting housings 36, 37 are respectively surrounded by a casing-type heating jacket 44, 45. The heating jackets 44, 45 have receiving holes distributed over the periphery—indicated for example by 46 and 47-, into which heating cartridges—not visible here—can respectively be inserted. The electric cables for this purpose run within protective pipes 48 and 49 (see FIG. 1).

The mixing head 6 is flanged onto the front end of the melting housing 36, 37. It connects the front ends of the melting housing 36, 37. The mixing head 6 is divided, one behind the other, into a first section 50 on the melting side and a second and a third section 51, 52. Two channels 53, 54 extend within the first section 50, the one channel 53 being open towards the passage channel 38, and the second channel 54 being open towards the passage channel 39. They are combined, thus forming a mixing channel 55 which passes through the second and the third section 51,52 and into which a static mixing insert 56 is inserted. The welding head 7 with a continuation 57 of the mixing channel 55 and the outlet 58 is placed on the third section 53.

The three sections 50, 51, 52 are braced with one another by means of screws (not shown here) which are inserted into screw channels 59, 60. Offset in the peripheral direction relative to the latter are bore holes into which heating cartridges are inserted. The electrical supply for the heating cartridges is provided via cables which run within a further protective pipe 61.

The supply of energy to the hydraulic motor 2 is provided by means of an external hydraulic pump (not shown) driven by an electric motor which are connected to the hand welder 1 and the hydraulic motor 2 by means of inward and outward hoses. Since a hydraulic oil with lubricating properties is used, a partial flow opens out into the interior of the gear housing 8 by means of a feed pipe 62 for the purpose of lubricating the spur gears 13, 14, 15 present here as well as the ball bearings 11, 12, 18, 19 and the oblique ball bearings 20, 21. After passing through the gear housing 8 the hydraulic oil is passed out of the gear housing 8 by means of the discharge pipe 63.

There is assigned to the hand welder 1 a likewise external hot air device in which hot air in the temperature range from 250 to 400° C. is generated and fed to the hand welder 1 by means of a blower and a hot air hose. It opens out here into a hot air pipe 64 running substantially parallel to the melting device 5, the mixing head 6 and the welding head 7 and which has a nozzle-type port 65 next to the welding head 7 and at the level of the outlet 58 of the latter.

A welding process is initiated by the hand welder 1 and in particular here the melting units 24, 25 and the mixing head 6 being brought to operating temperature in order to melt the welding filler located within the hand welder 1. Only when this has happened is the hydraulic motor 2 enabled. Welding filler wires are introduced into the feeder channels 30, 31 so that they come into the engagement region of the feeder screws 32, 33. At the same time the hot air device is actuated in order to bring the air pre-heating to operating temperature. The welding head 7 can then be placed over the weld seam to be produced. Hot air then flows out of the port 65 of the hot air pipe 64 onto the welding point so that it is plasticised.

Next the hydraulic motor 2 is actuated. The rotary motion of its output shaft 9 is transferred by the gear shaft 10 onto the first spur gear 13 and from here to the second spur gears 14, 15. In this way the feeder screws 32, 33 and the respectively adjoining extruder screws 44 and 41 are set in rotary motion. By means of the feeder thread 34, 35 the respective corresponding melt additive wire is fed into the feeder channel 30 and 31 and conveyed in the axial direction to the respective corresponding granulating device. Here the melt additive wires are granulated into individual pieces so that the melt additive enters into the passage channels 38, 39 in granular form. Here it is picked up by the respective corresponding extruder screws 40 and 41 and conveyed axially through the respective corresponding passage channel 38 or 39. Here the melt additive is heated as a result of heating by the heating cartridges sitting in the heating jackets 44, 45 and by friction to a temperature of normally over 200° C., by means of which the melt additive is melted.

The partial flows from the melt additive flowing out of the passage channels 38, 39 pass into the channels 53 and 54 and combine in the mixing channel 55 where they are mixed intensively by means of the mixing insert 56 in order to avoid any flow fronts. The temperature is thus maintained by the heating cartridges used here. The welding filler then passes in plasticised form onto the welding point via the welding head 7 and the outlet 58 of the latter.

1. A hand welder (1) for welding plastic workpieces by melting a plastic welding filler, comprising a feed device (4) for feeding the welding filler into a melting device (5) for melting the welding filler and to which a welding head (7) with an outlet (58) for the molten welding filler is attached on the outlet side, characterised in that the melting device (5) has at least two melting units (24, 25) disposed next to one another, and every melting unit (24, 25) has its own passage channel (38, 39) for the welding filler, the passage channels (38, 39) opening out into a mixing head (6) for mixing the molten welding fillers passing out of the passage channels (38, 39).

2. The hand welder according to claim 1, characterised in that the passage channels (38, 39) extend parallel to one another.

3. The hand welder according to claim 1, characterised in that the melting units (24, 25) are in the form of extruder units with extruder screws (40, 41) disposed in the passage channels (38, 39), and the extruder screws (40, 41) are coupled on the input side to a drive device (2).

4. The hand welder according to claim 3, characterised in that the drive device has a single drive motor (2) which is connected to the extruder screws (40, 41) by means of a transfer box (3).

5. The hand welder according to claim 4, characterised in that the transfer box (3) is provided in the form of spur gearing with a first gear wheel (13) on the drive side and gear wheels (14, 15) on the extruder side which cog directly and/or indirectly with the first gear wheel (13).

6. The hand welder according to claim 4, characterised in that the transfer box (3) is disposed within a gear housing (8) which has a flange for the drive motor (2) on the drive side.

7. The hand welder according to claim 4, characterised in that the drive motor is in the form of a hydraulic motor (2) which is connected or connectable by means of flexible hoses to a hydraulic pump.

8. The hand welder according to claim 7, characterised in that the hydraulic motor (2) is in the form of a gerotor motor, in particular an orbital motor.

9. The hand welder according to claim 6, characterised in that the transfer box (3) has a connection to the hydraulic pump such that the hydraulic oil conveyed by the hydraulic pump flows through the transfer box (3) in order to lubricate the latter.

10. The hand welder according to claim 1, characterised in that the melting units (24, 25) are separated from one another.

11. The hand welder according to claim 1, characterised in that, connected to the melting units (24, 25), the mixing head (6) has a first section (50) with outlet channels (53, 54) opening out into one another and a second section (51) adjoining the first which has a mixing channel (55) preferably with a static mixing insert (56).

12. The hand welder according to claim 11, characterised in that the first and second sections (50, 51) form two separate components which are, however, connected to one another.

13. The hand welder according to claim 1, characterised in that the mixing head (6) is provided with a heating device.

14. The hand welder according to claim 13, characterised in that the heating device of the mixing head (6) is provided with a temperature regulating device.

15. The hand welder according to claim 1, characterised in that the feed device (4) consists of separate feed units (22, 23), and a particular feed unit (22, 23) is assigned to every melting unit (24, 25).

16. The hand welder according to claim 15, characterised in that the units comprising the melting unit (24, 25) and the respective corresponding feed unit (22, 23) are separated from one another.

17. The hand welder according to claim 3, characterised in that every feed unit (22, 23) has its own wire feed and its own feeder screw (32, 33), every feeder screw (32, 33) being disposed coaxially to the respective corresponding extruder screw (40, 41) and being connected to the latter, and the feeder screws (40, 41) being coupled to the drive device (2).

18. The hand welder according to claim 1, characterised in that the melting units (24, 25) have separate heating units with temperature regulating devices which are independent of one another.

19. The hand welder according to claim 1, characterised in that a hot air device is provided which has an outlet opening (65) close to the welding head (7) and is provided with its own temperature regulating device.

20. The hand welder according to claim 19, characterised in that the hot air device has a hot air generator which is coupled or can be coupled by a hot air hose to a hot air pipe (64) leading to the welding head (7) and connected to the hand welder (1).
